(19) United States
(12) Patent Application Publication
(10) Pub. No.: US 2025/0056178 A1
(43) Pub. Date: Feb. 13, 2025

(54) APPARATUS AND METHOD FOR PROCESSING MULTI-CHANNEL AUDIO SIGNAL

(71) Applicant: SAMSUNG ELECTRONICS CO., LTD., Suwon-si (KR)

(72) Inventors: Sunghee HWANG, Suwon-si (KR); Sangchul KO, Suwon-si (KR); Kyungae KIM, Suwon-si (KR); Jungkyu KIM, Suwon-si (KR); Woohyun NAM, Suwon-si (KR); Yoonjae SON, Suwon-si (KR); Kyunggeun LEE, Suwon-si (KR); Tammy LEE, Suwon-si (KR); Hyunkwon CHUNG, Suwon-si (KR)

(73) Assignee: SAMSUNG ELECTRONICS CO., LTD., Suwon-si (KR)

(21) Appl. No.: 18/929,050

(22) Filed: Oct. 28, 2024

Related U.S. Application Data
(63) Continuation of application No. PCT/KR2023/004017, filed on Mar. 27, 2023.

(30) Foreign Application Priority Data
Apr. 28, 2022 (KR) 10-2022-0053112
Oct. 24, 2022 (KR) 10-2022-0137660

(51) Int. Cl. H04S 7/00

(52) U.S. Cl. CPC H04S 7/301; H04S 2400/01; H04S 2400/03

(57) ABSTRACT

Disclosed are an audio processing apparatus and method including obtaining at least one substream and additional information by parsing a bitstream, obtaining at least one audio signal of at least one channel group (CG) by decompressing the at least one substream, and obtaining a multi-channel audio signal by de-mixing the at least one audio signal of the at least one CG, based on the additional information. The additional information includes a weight index offset identified based on an energy value of a height channel of the multi-channel audio signal and an energy value of a surround channel of the multi-channel audio signal.

### CROSS-REFERENCE TO RELATED APPLICATIONS

This application is a bypass continuation application of International Application No. PCT/KR2023/004017 designating the United States, filed on Mar. 27, 2023, in the Korean Intellectual Property Receiving Office and claiming priority to Korean Patent Application No. 10-2022-0053112, filed on Apr. 28, 2022, in the Korean Intellectual Property Office, and Korean Patent Application No. 10-2022-0137660, filed on Oct. 24, 2022, in the Korean Intellectual Property Office, the disclosures of which are incorporated by reference herein in their entireties.

### BACKGROUND

### 1. Field

The present disclosure relates to the field of processing multi-channel audio signals. More particularly, the present disclosure relates to the field of processing audio signals of a subchannel layout (e.g., a listener front three-dimensional audio channel layout) from multi-channel audio signals.

### 2. Description of Related Art

General audio signals are two-dimensional audio signals, such as 2-channel, 5.1-channel, 7.1-channel, and 9.1-channel audio signals.

However, because audio information of two-dimensional audio signals in the height direction is uncertain, there is a need to generate three-dimensional audio signals (n-channel audio signals or multi-channel audio signals, where n is an integer greater than 2) so as to provide a spatial three-dimensional effect of sound.

In a related art channel layout for three-dimensional audio signals, channels are arranged omni-directionally centered on a listener. However, with the expansion of over-the-top (OTT) services, the increased resolution of televisions (TVs), and the larger screens of electronic devices such as tablets, viewers' needs to experience immersive audio, such as theater content, in a home environment are increasing. Therefore, there is a need to process audio signals of a three-dimensional audio channel layout in which channels are arranged in front of a listener (a listener front three-dimensional audio channel layout), taking into account the sound representation of an object (a sound source) on a screen.

### SUMMARY

According to an aspect of the disclosure, there is provided an audio processing method including obtaining at least one substream and additional information by parsing a bitstream; obtaining at least one audio signal of at least one channel group (CG) by decompressing the at least one substream; and obtaining a multi-channel audio signal by de-mixing the at least one audio signal of the at least one CG, based on the additional information, wherein the additional information includes a weight index offset identified based on an energy value of a height channel of the multi-channel audio signal and an energy value of a surround channel of the multi-channel audio signal.

The additional information may further include a first down-mix parameter, a second down-mix parameter, a third down-mix parameter, a fourth down-mix parameter, and a fifth down-mix parameter, and wherein the obtaining of the multi-channel audio signal may include: de-mixing the surround channel of the at least one audio signal, based on the first down-mix parameter, the second down-mix parameter, the third down-mix parameter, and the fourth down-mix parameter; dynamically determining the fifth down-mix parameter by using the weight index offset; and de-mixing a height channel of the at least one audio signal, based on the fifth down-mix parameter.

The dynamically determining of the fifth down-mix parameter by using the weight index offset may include: determining a weight index by cumulatively adding the weight index offset for each frame; and determining the fifth down-mix parameter as a predetermined value corresponding to the weight index.

The determining of the weight index may include: based on a result of cumulatively adding the weight index offset for each frame being less than or equal to a first value, determining the weight index to be the first value; based on the result of cumulatively adding the weight index offset for each frame being greater than a second value, determining the weight index to be the second value; and based on the result of cumulatively adding the weight index offset for each frame being a third value greater than the first value and less than the second value, determining the weight index to be the third value.

The bitstream is configured in a form of an open bitstream unit packet, and wherein the bitstream may include: non-timed metadata including at least one of codec information or static metadata; and at least one temporal unit including de-mixing information and the at least one substream.

According to an aspect of the disclosure, there is provided an audio processing method including: generating a down-mix parameter by using an audio signal; down-mixing the audio signal along a down-mix path determined in accordance with a channel layout generation rule, by using the down-mix parameter; generating at least one channel group in accordance with a channel group (CG) generation rule by using the down-mixed audio signal; generating at least one substream by compressing the at least one audio signal of the at least one CG; and generating a bitstream by packetizing the at least one substream and additional information, wherein the additional information includes a weight index offset identified based on an energy value of a height channel of the audio signal and an energy value of a surround channel of the audio signal.

The down-mix parameter may include a first down-mix parameter, a second down-mix parameter, a third down-mix parameter, a fourth down-mix parameter, and a fifth down-mix parameter, and wherein the generating of the down-mix parameter may include: identifying an audio scene type for the audio signal; generating the first down-mix parameter, the second down-mix parameter, the third down-mix parameter, and the fourth down-mix parameter, based on the identified audio scene type; identifying the energy value of the height channel of the audio signal and the energy value of the surround channel of the audio signal; and generating the fifth down-mix parameter, based on a relative difference between the identified energy value of the height channel and the identified energy value of the surround channel.

The generating of the down-mix parameter may include identifying the weight index offset, based on the identified energy value of the height channel and the identified energy value of the surround channel.

The down-mixing of the audio signal may include: down-mixing the surround channel of the audio signal by using the first down-mix parameter, the second down-mix parameter, the third down-mix parameter, and the fourth down-mix parameter; and down-mixing the height channel of the audio signal by using the fifth down-mix parameter.

The down-mixing of the height channel may include down-mixing the height channel by combining, through the fifth down-mix parameter, at least one audio signal included in the surround channel and at least one audio signal included in the height channel.

The bitstream is configured in a form of an open bitstream unit packet, and wherein the bitstream may include: non-timed metadata including at least one of codec information or static metadata; and at least one temporal unit including de-mixing information and the at least one substream.

A computer-readable recording medium may have stored thereon a computer program that, when executed by a processor, causes the processor to perform a method.

According to an aspect of the disclosure, there is provided an audio processing apparatus including: a memory storing one or more instructions for audio processing; and at least one processor, wherein the one or more instructions, when executed by the at least one processor, cause the audio processing apparatus to: obtain at least one substream and additional information by parsing a bitstream; obtain at least one audio signal of at least one channel group (CG) by decompressing the at least one substream; and obtain a multi-channel audio signal by de-mixing the at least one audio signal of the at least one CG, based on the additional information, wherein the additional information includes a weight index offset identified based on an energy value of a height channel of the multi-channel audio signal and an energy value of a surround channel of the multi-channel audio signal.

According to an aspect of the disclosure, there is provided an audio processing apparatus including: a memory storing one or more instructions for audio processing; and at least one processor, wherein the one or more instructions, when executed by the at least one processor, cause the audio processing apparatus to: generate a down-mix parameter by using an audio signal; down-mix the audio signal along a down-mix path determined in accordance with a channel layout generation rule, by using the down-mix parameter; generate at least one channel group in accordance with a channel group (CG) generation rule by using the down-mixed audio signal; generate at least one substream by compressing the at least one audio signal of the at least one CG; and generate a bitstream by packetizing the at least one substream and additional information, wherein the additional information includes a weight index offset identified based on an energy value of a height channel of the audio signal and an energy value of a surround channel of the audio signal.

### BRIEF DESCRIPTION OF DRAWINGS

The above and other aspects and/or features of one or more embodiments of the disclosure will be more apparent from the following detailed description, taken in conjunction with the accompanying drawings, in which:

FIG. 1A is a diagram for describing a scalable audio channel layout structure, according to an embodiment;

FIG. 1B is a diagram for describing an example of a specific scalable audio channel layout structure, according to an embodiment;

FIG. 2 illustrates a structure of a bitstream, according to an embodiment;

FIG. 3A is a block diagram illustrating a configuration of an audio encoding apparatus, according to an embodiment;

FIG. 3B is a block diagram illustrating a configuration of an audio encoding apparatus, according to an embodiment;

FIG. 3C is a block diagram illustrating a configuration of a pre-processing unit, according to an embodiment;

FIG. 3D illustrates a down-mix path, based on a channel layout generation rule, according to an embodiment;

FIG. 3E illustrates a down-mix mechanism, according to an embodiment.

FIG. 4A is a block diagram illustrating a configuration of a multi-channel audio decoding apparatus, according to an embodiment;

FIG. 4B is a block diagram illustrating a configuration of a multi-channel audio decoding apparatus, according to an embodiment;

FIG. 4C is an example of a relationship between a weight index (wIdx) and a fifth down-mix parameter (w), according to an embodiment;

FIG. 5 is a flowchart of an audio processing method according to an embodiment; and

FIG. 6 is a flowchart of an audio processing method, according to an embodiment.

### DETAILED DESCRIPTION

The present disclosure may allow for various changes and have various embodiments. One or more embodiments are illustrated in the drawings and described in detail. However, this is not intended to limit the present disclosure to particular embodiments, and it should be understood that the present disclosure is intended to include all variations, equivalents, and substitutes falling within the spirit and technical scope of the present disclosure.

In describing embodiments, when the detailed description of the relevant known technology is determined to unnecessarily obscure the gist of the present disclosure, the detailed description thereof may be omitted herein. Also, numbers (e.g., first, second, etc.) used in the description of embodiments are merely identification symbols for distinguishing one element from another.

When one element is referred to as being “connected” or “coupled” to another element, the one element may be directly connected or coupled to the other element, but it will be understood that the elements may be connected or coupled to each other via an intervening element therebetween unless otherwise stated.

Also, an element represented by “unit,” “module,” etc. in the present disclosure may be one element in which two or more elements are combined, or may be divided into two or more element for each more subdivided function. Also, each of the elements to be described below may additionally perform, in addition to the main function thereof, some or all of the functions that other elements are responsible for, and some of the main functions that the respective elements are responsible for may be dedicated by other elements.

In the present disclosure, a “multi-channel audio signal” may refer to an n-channel audio signal (where n is an integer greater than 2). A “mono channel audio signal” may be a one-dimensional audio signal, a “stereo channel audio signal” may be a two-dimensional audio signal, and a “multi-channel audio signal” may be a three-dimensional audio signal.

In the present disclosure, a “channel layout (CL)” may represent a combination of at least one channel and may specify the spatial arrangement of channels. The channel as used herein is a channel through which an audio signal is actually output, and thus, may be referred to as a presentation channel.

For example, the CL may be an X.Y.Z CL. Here, X may be the number of surround channels, Y may be the number of subwoofer channels, and Z may be the number of height channels (or top channels). The spatial location of each surround channel/subwoofer channel/height channel may be specified by the “CL.”

Examples of the “CL” include a 1.0.0 channel (mono channel) layout, a 2.0.0 channel (stereo channel) layout, a 5.1.0 CL, a 5.1.2 CL, a 5.1.4 CL, a 7.1.0 CL, a 7.1.2 CL, a 7.1.4 CL, and a 3.1.2 CL, but the present disclosure is not limited thereto, and there may be various CLs.

Based on the spatial location of each channel, the channels of the “CL” may be named as follows.

For example, in the 1.0.0 CL, a first surround channel may be referred to as a mono channel. In the 2.0.0 CL, a first surround channel may be referred to as an L2 channel and a second surround channel may be referred to as an R2 channel.

Here, “L” indicates a channel located to the left relative to the listener and “R” indicates a channel located to the right relative to the listener. “2” indicates a surround channel of a case where there are a total of two surround channels.

In the 5.1.0 CL, a first surround channel may be referred to as an L5 channel, a second surround channel may be referred to as an R5 channel, a third surround channel may be referred to as a C channel, a fourth surround channel may be referred to as an Ls5 channel, and a fifth surround channel may be referred to as an Rs5 channel. Here, “C” indicates a channel located in the center relative to the listener. “s” indicates a channel located at a side.

In the 5.1.0 CL, a first subwoofer channel may be referred to as an LFE channel. Here, LFE may represent a low frequency effect. That is, the LFE channel may be a channel for outputting LFE sounds.

The name of the surround channel in the 5.1.2 CL and the 5.1.4 CL and the name of the surround channel in the 5.1.0 CL may be the same as each other.

Similarly, the name of the subwoofer channel in the 5.1.2 CL and the 5.1.4 CL and the name of the subwoofer channel in the 5.1.0 CL may be the same as each other.

In the 5.1.2 CL, a first height channel may be referred to as an Hl5 (or Ltf2) channel, and a second height channel may be referred to as an Hr5 (or Rtf2) channel. Here H indicates the height channel.

In the 5.1.4 CL, a first height channel may be referred to as an Hfl (or Ltf4) channel, a second height channel may be referred to as an Hfr (or Rtf4) channel, a third height channel may be referred to as an Hbl (or Ltb4) channel, and a fourth height channel may be referred to as an Hbr (or Rtb4) channel. Here, f indicates a front channel centered on the listener, and b indicates a back channel.

In the 7.1.0 CL, a first surround channel may be referred to as an L channel, a second surround channel may be referred to as an R channel, a third surround channel may be referred to as a C channel, a fourth surround channel may be referred to as an Ls (or Lss) channel, a fifth surround channel may be referred to as an Rs (or Rss) channel, a sixth surround channel may be referred to as an Lb (or Lrs) channel, and a seventh surround channel may be referred to as an Rb (or Rrs) channel.

In the 7.1.0 CL, a first subwoofer channel may be referred to as an LFE channel.

The name of the surround channel in the 7.1.2 CL and the 7.1.4 CL and the name of the surround channel in the 7.1.0 CL may be the same as each other.

Similarly, the name of the subwoofer channel in the 7.1.2 CL and the 7.1.4 CL and the name of the subwoofer channel in the 7.1.0 CL may be the same as each other.

In the 7.1.2 CL, a first height channel may be referred to as an Hl7 (or Ltf2) channel, and a second height channel may be referred to as an Hr7 (or Rtf2) channel.

In the 7.1.4 CL, a first height channel may be referred to as an Hfl (or Ltf4) channel, a second height channel may be referred to as an Hfr (or Rtf4) channel, a third height channel may be referred to as an Hbl (or Ltb4) channel, and a fourth height channel may be referred to as an Hbr (or Rtb4) channel.

In the 3.1.2 channel, a first surround channel may be referred to as an L3 channel, a second surround channel may be referred to as an R3 channel, and a third surround channel may be referred to as a C channel. In the 3.1.2 channel, a first subwoofer channel may be referred to as an LFE channel. In the 3.1.2 channel, a first height channel may be referred to as an Hfl3 (or Ltf3) channel, and a second height channel may be referred to as an Hfr3 (or Ltb3) channel.

Here, some channels may be named differently depending on the CL, but may represent the same channel. For example, the Hl5 channel and the Hl7 channel may be the same channel. Similarly, the Hr5 channel and the Hr7 channel may be the same channel.

The names of the channels in the CLs described above are summarized in Table 1 below.

TABLE 1

| CL | Name of channels |
|---|---|
| 1.0.0 | Mono |
| 1.0.0 | L2/R2 |
| 5.1.0 | L5/C/R5/Ls5/Rs5/LFE |
| 5.1.2 | L5/C/R5/Ls5/Rs5/Hl5/Hr5/LFE |
| 5.1.4 | L5/C/R5/Ls5/Rs5/Hfl/Hfr/Hbl/Hbr/LFE |
| 7.1.0 | L/C/R/Ls/Rs/Lb/Rb/LFE |
| 7.1.2 | L/C/R/Ls/Rs/Lb/Rb/Hl7/Hr7/LFE |
| 7.1.4 | L/C/R/Ls/Rs/Lb/Rb/Hfl/Hfr/Hbl/Hbr/LFE |
| 3.1.2 | L3/C/R3/Hfl3/Hfr3/LFE |

In the present disclosure, the “three-dimensional audio signal” may refer to an audio signal that is capable of determining the distribution of sound and the location of sound sources in a three-dimensional space. In the present disclosure, the “listener front three-dimensional audio channel” may refer to a three-dimensional audio channel based on a layout of an audio channel arranged in front of the listener. The “listener front three-dimensional audio channel” may also be referred to as a “front 3D audio channel.” In particular, the “listener front three-dimensional audio channel” may be referred to as a “screen-centered three-dimensional audio channel” because the listener front three-dimensional audio channel is a three-dimensional audio channel based on the layout of the audio channel centered on the screen located in front of the listener. In the present disclosure, a “listener omni-direction three-dimensional audio channel” may refer to a three-dimensional audio channel based on the layout of the audio channel arranged omni-directionally centered on the listener. The “listener omni-direction three-dimensional audio channel” may also be referred to as a “full 3D audio channel.” Here, the omni-direction may refer to all directions including front, side, and back. In particular, the “listener omni-direction three-dimensional audio channel” may be referred to as a “listener-centered three-dimensional audio channel” because the listener omni-direction three-dimensional audio channel is a three-dimensional audio channel based on the layout of the audio channel arranged omni-directionally centered on the listener.

In the present disclosure, a “channel group (CG)” is a type of data unit and may include a (compressed) audio signal of at least one channel. Specifically, the CG may include at least one of a base channel group (BCG) that is independent of other channel groups and a dependent channel group (DCG) that is dependent on at least one CG. At this time, a target CG on which a DCG depends may be another DCG, and in particular, may be a DCG related to a lower CL. Alternatively, the CG on which the DCG depends may be a BCG. Since the “CG” includes data of a type of CG, the CG may be referred to as a “data group (coding group).” The DCG is a group used to further extend the number of channels from the channels included in the BCG, and may be referred to as a scalable CG or an extended CG.

The audio signal of the “BCG” may include the audio signal of the mono channel or the audio signal of the stereo channel. Without being limited thereto, the audio signal of the “BCG” may include the audio signal of the listener front three-dimensional audio channel.

For example, the audio signal of the “DCG” may include the audio signal of the remaining channel other than the audio signal of the “BCG” among the audio signals of the listener front three-dimensional audio channel or the audio signals of the listener omni-direction three-dimensional audio channel. At this time, a portion of the audio signal of the remaining channel may be an audio signal in which an audio signal of at least one channel is mixed (i.e., an audio signal of a mixed channel).

For example, the audio signal of the “BCG” may include the audio signal of the mono channel or the audio signal of the stereo channel. The “multi-channel audio signal” restored based on the audio signals of the “BCG” and the “DCG” may be the audio signal of the listener front three-dimensional audio channel or the audio signal of the listener omni-direction audio channel.

In the present disclosure, “up-mixing” may refer to an operation of increasing the number of presentation channels of the output audio signal through de-mixing, compared to the number of presentation channels of the input audio signal.

In the present disclosure, “de-mixing” may refer to an operation of separating an audio signal of a specific channel from an audio signal in which audio signals of various channels are mixed (i.e., an audio signal of a mixed channel). At this time, “de-mixing” may be implemented as an operation using a “de-mixing matrix” (or a “down-mixing matrix” corresponding thereto), and the “de-mixing matrix” may include at least one “de-mix parameter” (or “down-mix parameter” corresponding thereto) as a coefficient of the de-mixing matrix (or the “down-mixing matrix” corresponding thereto). Alternatively, “de-mixing” may be implemented as a mathematical operation based on a part of the “de-mixing matrix” (or the “down-mixing matrix” corresponding thereto), but the present disclosure is not limited thereto, and “de-mixing” may be implemented in various ways. As described above, “de-mixing” may be related to “up-mixing.”

“Mixing” refers to any operation of generating an audio signal of a new channel (i.e., a mixed channel) by adding values respectively obtained by multiplying audio signals of a plurality of channels by corresponding weights (i.e., by mixing audio signals of a plurality of channels).

“Mixing” may be divided into narrow sense “mixing” to be performed in an audio encoding apparatus and “de-mixing” to be performed in an audio decoding apparatus.

“Mixing” to be performed in an audio encoding apparatus may be implemented as an operation using a “(down-) mixing matrix,” and the “(down-) mixing matrix” may include at least one “(down-) mix parameter” as a coefficient of the (down-) mixing matrix. Alternatively, “(down-) mixing” may be implemented as a mathematical operation based on a part of the “(down-) mixing matrix,” but the present disclosure is not limited thereto, and “(down-) mixing” may be implemented in various ways.

In the present disclosure, “up-mix CG” may refer to a group including at least one up-mixed channel, and “up-mixed channel” may refer to a de-mixed channel separated through de-mixing of the audio signal of the encoded/decoded channel. The “up-mix CG” in a narrow sense may include only “up-mixed channels.” However, the “up-mix CG” in a broad sense may include not only “up-mixed channels” but also “encoded/decoded channels.” Here, the “decoded/decoded channel” refers to an independent channel of an audio signal that has been encoded (compressed) and included in a bitstream, or an independent channel of an audio signal obtained by decoding from a bitstream. At this time, a separate (de)-mixing operation is not required to obtain the audio signal of the encoded/decoded channel.

The audio signal of the “up-mix CG” in a broad sense may be a multi-channel audio signal, and the output multi-channel audio signal is an audio signal output to a device such as a speaker and may be one of at least one multi-channel audio signal (i.e., an audio signal of at least one up-mix CG).

In the present disclosure, “down-mixing” may refer to an operation of decreasing the number of presentation channels of the output audio signal through mixing, compared to the number of presentation channels of the input audio signal.

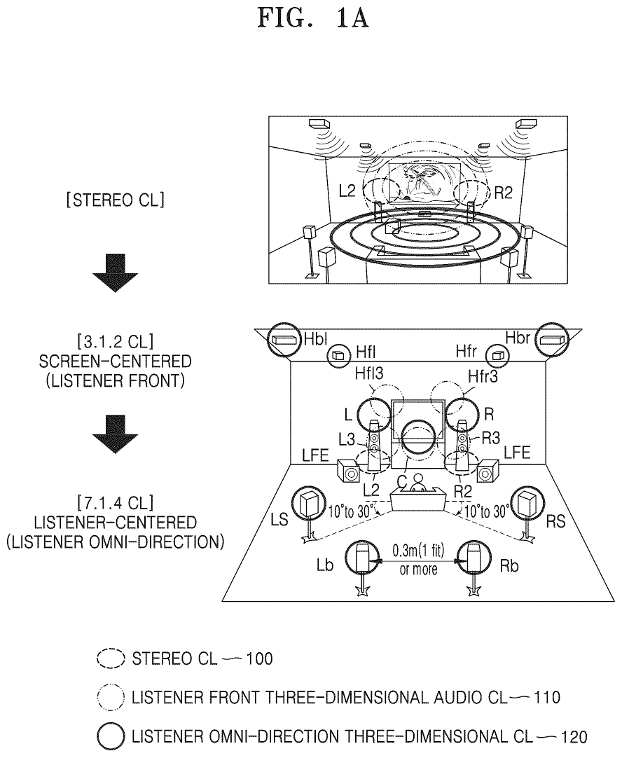

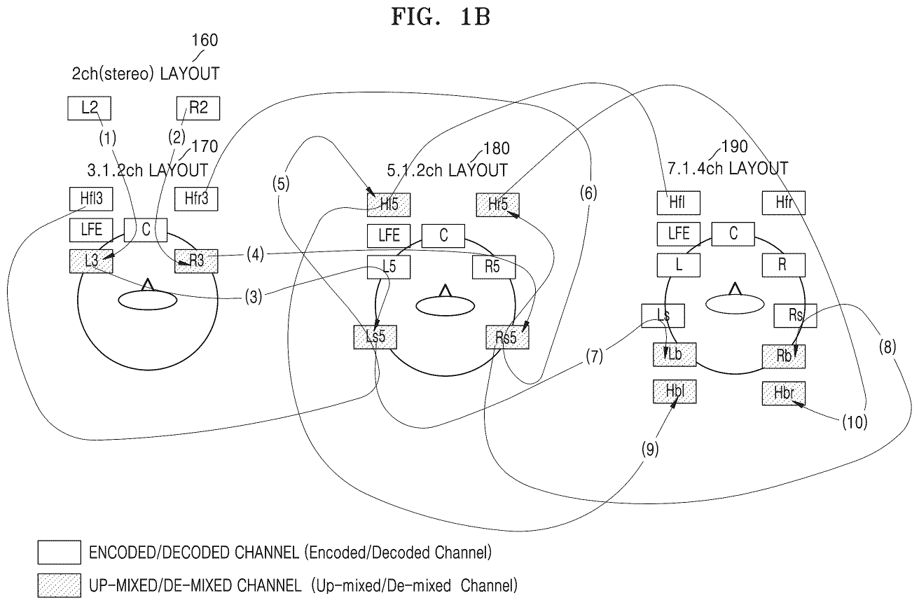

FIG. 1A is a diagram for describing a scalable audio CL structure according to an embodiment.

A related art three-dimensional audio decoding apparatus received a compressed audio signal of independent channels of a specific CL from a bitstream. The related art three-dimensional audio decoding apparatus restored an audio signal of a listener omni-direction three-dimensional audio channel by using a compressed audio signal of independent channels received from a bitstream. At this time, only the audio signal of the specific CL could be restored.

Alternatively, the related art three-dimensional audio decoding apparatus received a compressed audio signal of independent channels (a first independent CG) of a specific CL from a bitstream.

For example, the specific CL may be a 5.1 CL, and in this case, the compressed audio signal of the first independent CG may be compressed audio signals of five surround channels and one subwoofer channel.

Here, in order to increase the number of channels, the related art three-dimensional audio decoding apparatus additionally received a compressed audio signal of other channels (a second independent CG) independent of the first independent CG. For example, the compressed audio signal of the second independent CG may be a compressed audio signal of two height channels.

That is, the related art three-dimensional audio decoding apparatus restored an audio signal of a listener omni-direction three-dimensional audio channel by using the compressed audio signal of the second independent CG received from the bitstream, separately from the compressed audio signal of the first independent CG received from the bitstream. Accordingly, the audio signal with the increased number of channels was restored. Here, the audio signal of the listener omni-direction three-dimensional audio channel may be a 5.1.2 channel audio signal.

On the other hand, a legacy audio decoding apparatus that supports only reproduction of audio signals of a stereo channel could not properly process a compressed audio signal included in a bitstream.

In addition, the related art three-dimensional audio decoding apparatus that supports reproduction of three-dimensional audio signals also first decompressed (decoded) the compressed audio signals of the first independent CG and the second independent CG so as to reproduce the audio signal of the stereo channel. Thereafter, the related art three-dimensional audio decoding apparatus performed up-mixing on the decompressed audio signal. However, there was the inconvenience of having to perform operations such as up-mixing so as to reproduce the audio signals of the stereo channel.

Therefore, a scalable CL structure capable of processing compressed audio signals in the legacy audio decoding apparatus is required. Furthermore, in an audio decoding apparatus 400 that supports reproduction of three-dimensional audio signals, according to an embodiment, a scalable CL structure capable of processing compressed audio signals in accordance with a three-dimensional audio CL supported for reproduction is required. Here, the scalable CL structure refers to a layout structure in which the number of channels may be freely increased from a base CL.

The audio decoding apparatus 400 according to an embodiment may restore an audio signal of a scalable CL structure from a bitstream. In accordance with the scalable CL structure according to an embodiment, the number of channels may be increased from a stereo CL 100 to a listener front three-dimensional audio CL 110. Furthermore, in accordance with the scalable CL structure, the number of channels may be increased from the listener front three-dimensional audio CL 110 to a listener omni-direction three-dimensional audio CL 120. For example, the listener front three-dimensional audio CL 110 may be a 3.1.2 CL. The listener omni-direction three-dimensional audio CL 120 may be a 5.1.2 or 7.1.2 CL. However, the scalable CL that may be implemented in the present disclosure is not limited thereto.

As a BCG, audio signals of a related art stereo channel may be compressed. Since the legacy audio decoding apparatus is capable of decompressing the compressed audio signal of the BCG from the bitstream, the audio signals of the related art stereo channel may be smoothly reproduced.

Additionally, as a DCG, audio signals of the remaining channels other than the audio signals of the related art stereo channel among multi-channel audio signals may be compressed.

However, in the process of increasing the number of channels, some audio signals of the CG may be audio signals in which signals of some independent channels among audio signals of a specific CL are mixed.

Accordingly, the audio decoding apparatus 400 may de-mix some of the audio signals of the BCG and the audio signals of the DCG and generate audio signals of an up-mixed channel included in the specific CL.

On the other hand, one or more DCGs may be present. For example, the audio signals of the remaining channels other than the audio signals of the stereo channel among the listener front three-dimensional audio CL 110 may be compressed as audio signals of the first DCG.

The audio signals of the remaining channels other than the audio signals of the channels restored from the BCG and the first DCG among the listener omni-direction three-dimensional audio CL 120 may be compressed as audio signals of the second DCG.

The audio decoding apparatus 400 according to an embodiment may support reproduction of the audio signals of the listener omni-direction three-dimensional audio CL 120.

Therefore, the audio decoding apparatus 400 according to an embodiment may restore the audio signals of the listener omni-direction three-dimensional audio CL 120, based on the audio signals of the BCG and the audio signals of the first DCG and the second DCG.

The legacy audio signal processing apparatus may ignore compressed audio signals of DCGs that cannot be restored from the bitstream and reproduce only audio signals of the stereo channel restored from the bitstream.

Similarly, the audio decoding apparatus 400 may process the compressed audio signals of the BCG and the DCG and restore audio signals of CLs that are supportable among the scalable CLs. The audio decoding apparatus 400 is unable to restore compressed audio signals related to unsupported upper CLs from the bitstream. Accordingly, the compressed audio signals related to the upper CLs that are not supported by the audio decoding apparatus 400 may be ignored, and only audio signals of supportable CLs may be restored from the bitstream.

In particular, the related art audio encoding apparatus and audio decoding apparatus compress and decompress only audio signals of independent channels of a specific CL. Therefore, only compression and decompression of audio signals of a limited CL were possible.

However, according to the audio encoding apparatus 300 and the audio decoding apparatus 400 of an embodiment, which are apparatuses for supporting a scalable CL, the audio signals of the stereo CL may be transmitted and restored. In addition, according to the audio encoding apparatus 300 and the audio decoding apparatus 400 of an embodiment, the audio signals of the listener front three-dimensional CL may be transmitted and restored. Furthermore, according to the audio encoding apparatus 300 and the audio decoding apparatus 400 of an embodiment, the audio signals of the listener omni-direction three-dimensional CL may be transmitted and restored.

That is, the audio encoding apparatus 300 and the audio decoding apparatus 400 according to an embodiment may transmit and restore the audio signals, based on the stereo CL. In addition, the audio encoding/decoding apparatuses 300 and 400 according to an embodiment may freely convert audio signals of a current CL into audio signals of different CLs. The conversion between CLs is possible through mixing/de-mixing between audio signals of channels included in different CLs.

The audio encoding/decoding apparatuses 300 and 400 according to an embodiment support conversion between various CLs, and thus, may transmit and reproduce audio signals of various three-dimensional CLs. In other words, channel independence is not guaranteed between the listener front CL and the listener omni-direction CL or between the stereo CL and the listener front channel layout, but free conversion may be possible through mixing/de-mixing of audio signals.

Since the audio encoding/decoding apparatuses 300 and 400 according to an embodiment support processing of the audio signals of the listener front CL, audio signals corresponding to a speaker placed at the center of the screen may be transmitted and restored to thereby improve a sense of immersion for the listener.

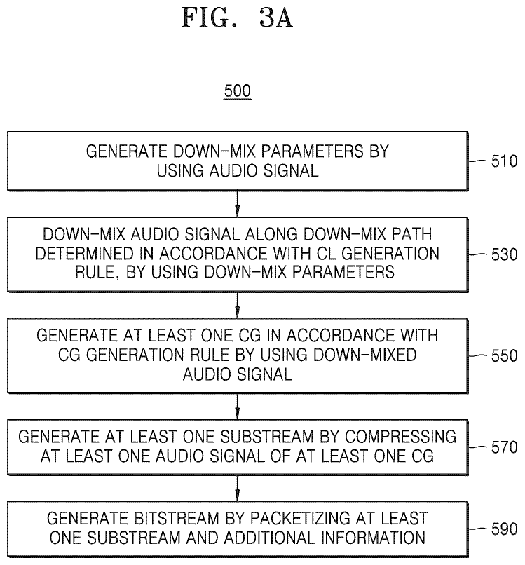

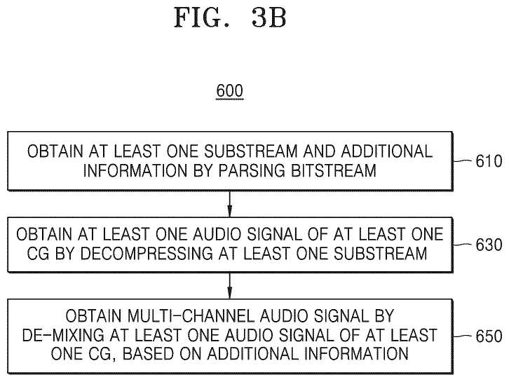

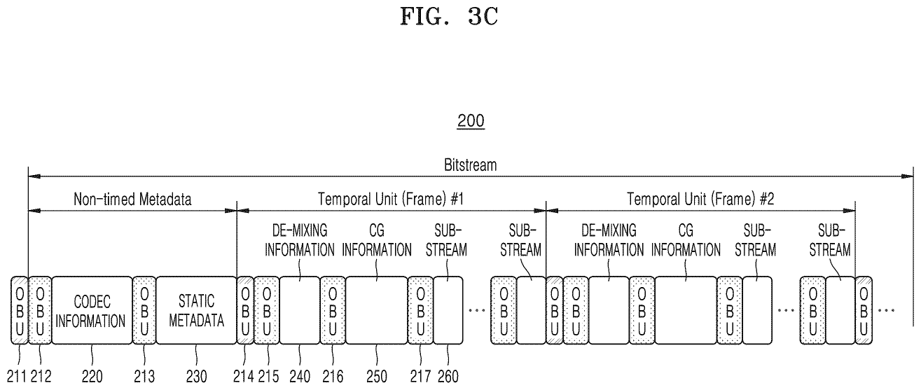

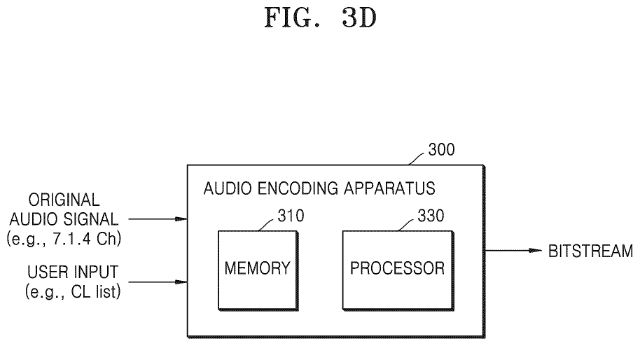

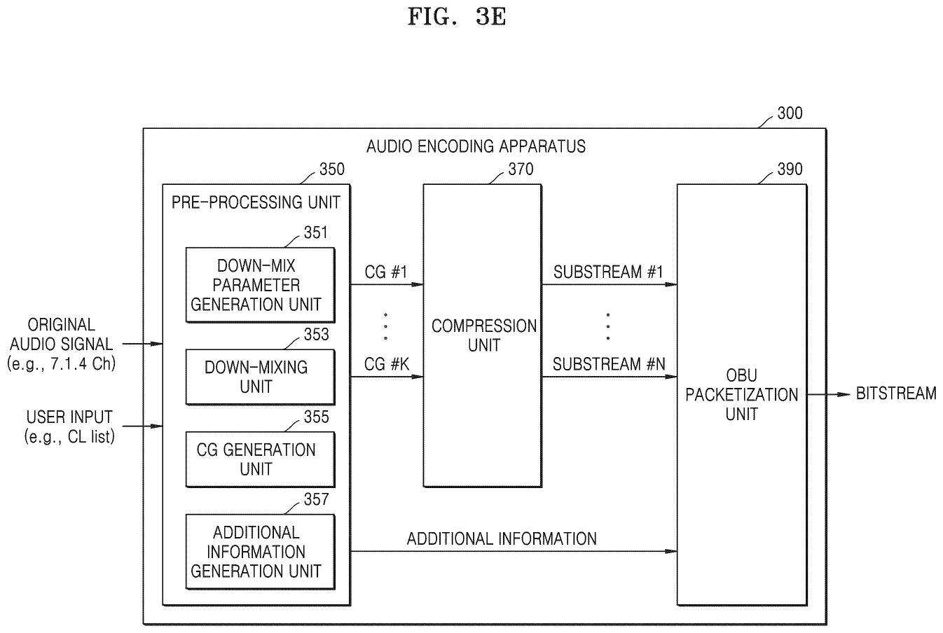

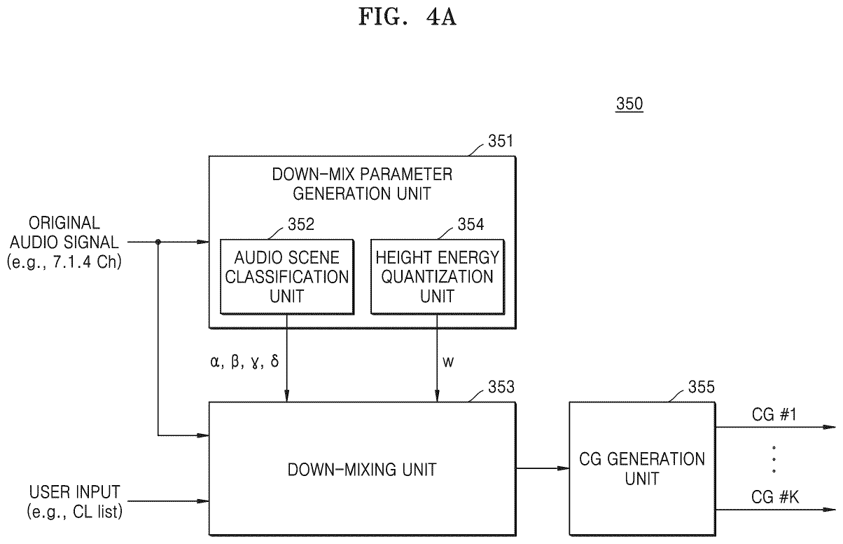

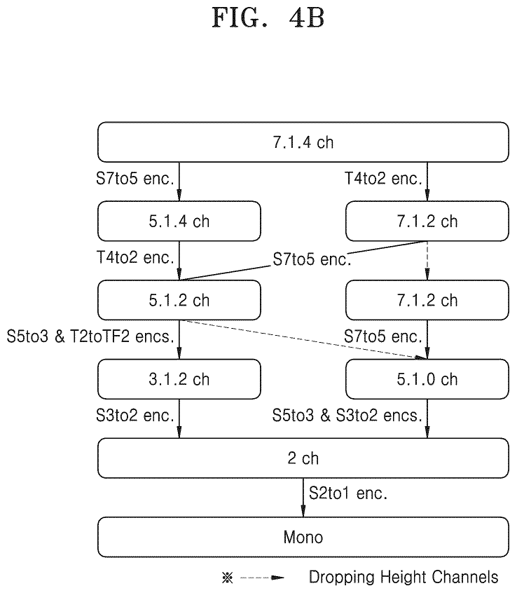

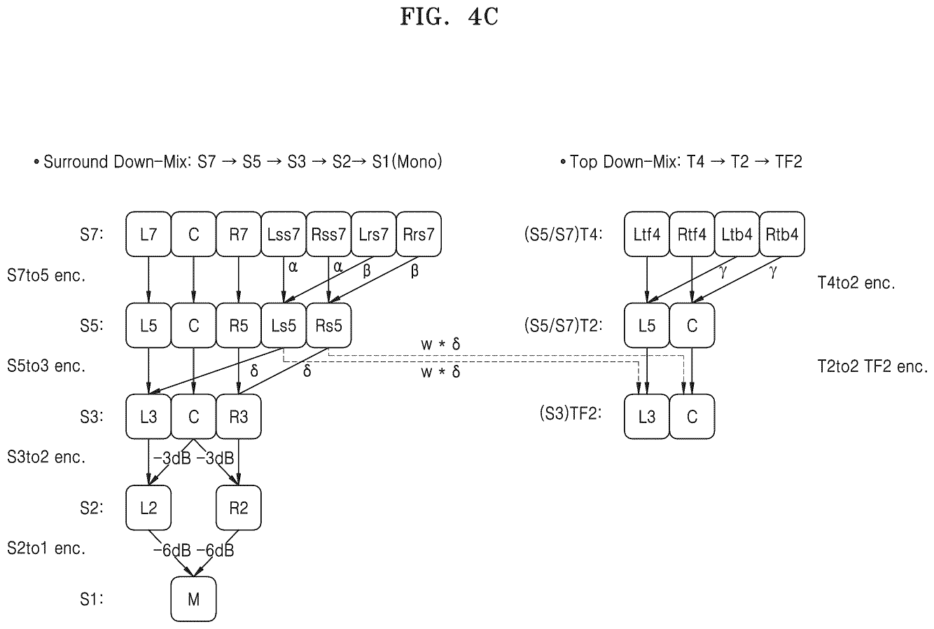

Detailed operations of the audio encoding/decoding apparatuses 300 and 400 according to an embodiment are described below with reference to FIGS. 3A to 4C.

FIG. 1B is a diagram for describing an example of a specific scalable audio CL structure.

Referring to FIG. 1B, in order to transmit audio signals of a stereo CL 160, the audio encoding apparatus 300 may generate a compressed audio signal (an A/B signal) of a BCG by compressing an L2/R2 signal.

At this time, the audio encoding apparatus 300 may generate an audio signal of the BCG by compressing the L2/R2 signal.

In addition, in order to transmit an audio signal of a 3.1.2 CL 170, which is one of listener front three-dimensional audio channels, the audio encoding apparatus 300 may generate a compressed audio signal of a DCG by compressing C, LFE, Hfl3, and Hfr3 signals. The audio decoding apparatus 400 may restore the L2/R2 signal by decompressing the compressed audio signal of the BCG. In addition, the audio decoding apparatus 400 may restore the C, LFE, Hfl3, and Hfr3 signals by decompressing the compressed audio signal of the DCG.

The audio decoding apparatus 400 may restore the L3 signal of the 3.1.2 CL 170 by de-mixing the L2 signal and the C signal (1). The audio decoding apparatus 400 may restore the R3 signal of the 3.1.2 channel by de-mixing the R2 signal and the C signal (2).

Ultimately, the audio decoding apparatus 400 may output the L3, R3, C, Lfe, Hfl3, and Hfr3 signals as the audio signals of the 3.1.2 CL 170.

On the other hand, in order to transmit an audio signal of a listener omni-direction 5.1.2 CL 180, the audio encoding apparatus 300 may generate a compressed audio signal of a second DCG by additionally compressing L5 and R5 signals.

As described above, the audio decoding apparatus 400 may restore the L2/R2 signal by decompressing the compressed audio signal of the BCG, and may restore the C, LFE, Hfl3, and Hfr3 signals by decompressing the compressed audio signal of the first DCG. Additionally, the audio decoding apparatus 400 may restore the L5 and R5 signals by decompressing the compressed audio signal of the second DCG. In addition, as described above, the audio decoding apparatus 400 may restore the L3 and R3 signals by de-mixing some of the decompressed audio signals.

Additionally, the audio decoding apparatus 400 may restore an Ls5 signal by de-mixing the L3 and L5 signals (3). The audio decoding apparatus 400 may restore an Rs5 signal by de-mixing the R3 and R5 signals (4). The audio decoding apparatus 400 may restore an Hl5 signal by de-mixing the Hfl3 signal and the Ls5 signal (5).

The audio decoding apparatus 400 may restore an Hr5 signal by de-mixing the Hfr3 signal and the Rs5 signal (6). Hfr3 and Hr5 are respectively the front right channels among the height channels.

Ultimately, the audio decoding apparatus 400 may output the Hl5, Hr5, LFE, L, R, C, Ls5, and Rs5 signals as the audio signals of the 5.1.2 CL 180.

On the other hand, in order to transmit an audio signal of a 7.1.4 CL 190, the audio encoding apparatus 300 may additionally compress the Hfl, Hfr, Ls, and Rs signals as audio signals of a third DCG.

As described above, the audio decoding apparatus 400 may decompresses the compressed audio signal of the BCG, the compressed audio signal of the first DCG, and the compressed audio signal of the second DCG, and may restore the Hl5, Hr5, LFE, L, R, C, Ls5, and Rs5 signals through the de-mixings (1), (2), (3), (4), (5), and (6).

Additionally, the audio decoding apparatus 400 may restore the Hfl, Hfr, Ls, and Rs signals by decompressing the compressed audio signal of the third DCG. The audio decoding apparatus 400 may restore the Lb signal of the 7.1.4 CL 190 by de-mixing the Ls5 signal and the Ls signal (7).

The audio decoding apparatus 400 may restore the Rb signal of the 7.1.4 CL 190 by de-mixing the Rs5 signal and the Rs signal (8). The audio decoding apparatus 400 may restore the Hbl signal of the 7.1.4 CL 190 by de-mixing the Hfl signal and the Hl5 signal (9).

The audio decoding apparatus 400 may restore the Hbr signal of the 7.1.4 CL 190 by de-mixing (or mixing) the Hfr signal and the Hr5 signal (10).

Ultimately, the audio decoding apparatus 400 may output Hfl, Hfr, LFE, C, L, R, Ls, Rs, Lb, Rb, Hbl, and Hbr signals as the audio signals of the 7.1.4 CL 190.

Accordingly, by supporting the scalable CL in which the number of channels increases through the de-mixing operation, the audio decoding apparatus 400 may restore, in addition to the audio signals of the related art stereo CL, the audio signals of the listener front three-dimensional audio channel and the audio signals of the listener omni-direction three-dimensional audio channel.

The scalable CL structure described above in detail with reference to FIG. 1B is only an example, and the CL structure may be implemented scalably in the form including various CLs.

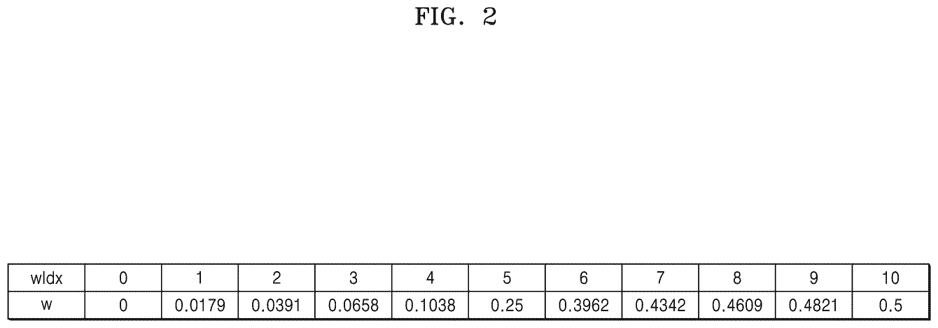

FIG. 2 illustrates a structure of a bitstream according to an embodiment.

The bitstream according to an embodiment may be configured in the form of an open bitstream unit (OBU) packet.

The bitstream according to an embodiment may include an OBU, non-timed metadata, and a temporal unit.

The OBU may include a 1- or 2-byte header that may identify a type of OBU, and may be located at the front of each data included in the bitstream and indicate the start of the data. Depending on the type of OBU, the OBU may transmit data, such as codec information 220, static metadata 230, de-mixing information 240, CG information 250, and substream 260.

For example, a first OBU 211 is a stream indicator and may be located at the beginning of the bitstream and indicate the start of the bitstream. A second OBU 212 is an OBU with a payload and may be located at the front of the codec information 220. A third OBU 213 is an OBU with a payload and may be located at the front of the static metadata 230. A fourth OBU 214 is a temporal delimiter and may be located at the front of the temporal unit and indicate the start of the temporal unit. A fifth OBU 215 is an OBU with a payload and may be located at the front of the de-mixing information 240. A sixth OBU 216 is an OBU with a payload and may be located at the front of the CG information 250. A seventh OBU 217 is an OBU with a payload and may be located at the front of the substream 260.

The non-timed metadata is metadata that does not change over time and may include the codec information 220 and the static metadata 230.

The codec information 220 is information about a codec used to compress the bitstream and may include, for example, information about a codec ID (Codec_ID) (e.g., mp4a), an object type (e.g., AAC-LC), a stream type (e.g., video or audio), or a channel configuration (e.g., 2-channel).

The static metadata 230 may include information about the configuration of audio data included in the bitstream and may include, for example, information about the CL of audio data.

The temporal unit corresponds to an audio frame and may include de-mixing information 240, CG information 250, and at least one substream 260.

The de-mixing information 240 may include information necessary for the audio decoding apparatus 400 to decode the substream 260. For example, the de-mixing information 240 may include down-mix parameter information α, β, γ, δ, and w.

The CG information 250 may include information about a CG generated in accordance with a CG generation rule.

The de-mixing information 240 and the CG information 250 are metadata of the substream 260, which is a compressed audio signal, and may be referred to as timed metadata because the de-mixing information 240 change over time or according to the frame.

The substream 260 is an audio signal compressed by the audio encoding apparatus 300. As described below, the audio encoding apparatus 300 may generate the substream 260 by compressing an audio signal of a CG generated by down-mixing an original audio signal, and the audio decoding apparatus 400 may restore the audio signal of the CG by decompressing the substream 260 and then output a multi-channel audio signal through de-mixing.

FIG. 3A is a block diagram illustrating the configuration of the audio encoding apparatus according to an embodiment.

The audio encoding apparatus 300 includes a memory 310 and a processor 330. The audio encoding apparatus 300 may be implemented as an apparatus capable of processing audio, such as a server, a television (TV), a camera, a mobile phone, a tablet personal computer (PC), or a laptop.

Although the memory 310 and the processor 330 are illustrated separately in FIG. 3A, the memory 310 and the processor 330 may be implemented through a single hardware module (e.g., a chip).

The processor 330 may be implemented as a dedicated processor for neural network-based audio processing. Alternatively, the processor 330 may be implemented through a combination of software and a general-purpose processor, such as an application processor (AP), a central processing unit (CPU), or a graphic processing unit (GPU). The dedicated processor may include a memory for implementing an embodiment of the present disclosure, or may include a memory processing unit for using an external memory.

The processor 330 may include a plurality of processors. In this case, the processor 330 may be implemented through a combination of dedicated processors, or may be implemented through a combination of software and a plurality of general-purpose processors, such as AP, CPU, or GPU.

The memory 310 may store one or more instructions for audio processing. In an embodiment, the memory 310 may store a neural network. When the neural network is implemented in the form of a dedicated hardware chip for artificial intelligence or is implemented as part of an existing general-purpose processor (e.g., a CPU or an AP) or a dedicated graphics processor (e.g., a GPU), the neural network may not be stored in the memory 310. The neural network may be implemented by an external device (e.g., a server). In this case, the audio encoding apparatus 300 may request processing by the neural network from the external device and receive, from the external device, result information based on the neural network.

The processor 330 obtains consecutive encoded (compressed) frames by sequentially processing consecutive frames according to instructions stored in the memory 310. The consecutive frames may refer to frames constituting audio.

The processor 330 may receive an original audio signal as input, perform an audio processing operation, and output a bitstream including a compressed audio signal (substream). At this time, the original audio signal may be a multi-channel audio signal. The compressed audio signal may be a multi-channel audio signal having channels, the number of which is less than or equal to the number of channels of the original audio signal.

At this time, the bitstream may include a BCG and may further include n DCGs (where n is an integer greater than or equal to 1). Accordingly, the number of channels may be freely increased according to the number of DCGs.

FIG. 3B is a block diagram illustrating a configuration of an audio encoding apparatus according to an embodiment.

Referring to FIG. 3B, the audio encoding apparatus 300 may include a pre-processing unit 350, a compression unit 370, and an OBU packetization unit 390. The pre-processing unit 350 may include a down-mix parameter generation unit 351, a down-mixing unit 353, a CG generation unit 355, and an additional information generation unit 357.

Referring back to FIG. 3A, as described above, the audio encoding apparatus 300 may include the memory 310 and the processor 330, and instructions for implementing the respective components 350, 351, 353, 355, 357, 370, and 390 of FIG. 3B may be stored in the memory 310 of FIG. 3A.

The processor 330 may execute the instructions stored in the memory 310.

The pre-processing unit 350 may generate at least one audio signal of at least one CG by using an original audio signal and a user input. Here, the original audio signal may be a multi-channel audio signal, and the user input may be a target CL list to be converted from the original audio signal.

For example, when the original audio signal is an audio signal of a 7.1.4 CL and the CL to be converted is 2.0.0 channel, 3.1.2 channel, 5.1.2 channel, and 7.1.4 channel, the pre-processing unit 350 may generate 2-channel audio signals (L2 and R2) as audio signals of a first CG from the audio signal of the 7.1.4 CL, may generate 4-channel audio signals (C, LFE, Hfl3, and Hfr3) as audio signals of a second CG, may generate 2-channel audio signals (L5 and R5) as audio signals of a third CG, and may generate 4-channel audio signals (Ls, Rs, Hfl, and Hfr) as audio signals of a fourth CG. Here, the first CG may be a BCG, and the second CG, the third CG, and the fourth CG may be respectively a first DCG, a second DCG, and a third DCG.

A detailed process in which the pre-processing unit 350 generates at least one audio signal of at least one CG from the original audio signal, including the operations of the down-mix parameter generation unit 351, the down-mixing unit 353, and the CG generation unit 355, is described below with reference to FIGS. 3C to 3E.

The additional information generation unit 357 may generate additional information, based on the original audio signal. The additional information is information related to the multi-channel audio signal and may be a variety of information for restoration of the multi-channel audio signal. For example, the additional information may include at least one of codec information 220, static metadata 230, de-mixing information 240, and CG information 250.

For example, the additional information may include an audio object signal of a listener front three-dimensional audio channel indicating at least one of an audio signal, a location, a shape, an area, and a direction of an audio object (a sound source). Alternatively, the additional information may include information about the total number of audio streams including a base channel audio stream and a dependent channel audio stream. In addition, the additional information may include down-mix gain information. The additional information may include channel mapping table information. The additional information may include loudness information. The additional information may include LFE gain information. The additional information may include dynamic range control (DRC) information. The additional information may include CL rendering information. The additional information may further include information about the number of coupled audio streams, information indicating a multi-CL, information about the presence or absence of dialogue in the audio signal and a dialogue level, information indicating whether to output an LFE, information about the presence or absence of an audio object on a screen, information about the presence or absence of an audio signal of a continuous audio channel (or a scene-based audio signal or an ambisonic audio signal), and information about the presence or absence of an audio signal of a discrete audio channel (or an object-based audio signal or an audio signal of a spatial multi-channel). The additional information may include information about de-mixing including at least one de-mix parameter of a de-mixing matrix for restoring a multi-channel audio signal. Since de-mixing and (down-) mixing are operations that correspond to each other, the information about de-mixing may correspond to information about (down-) mixing and the information about de-mixing may include information about (down-) mixing. For example, the information about de-mixing may include at least one (down-) mix parameter of a (down-) mixing matrix. The de-mix parameter may be obtained based on the (down-) mix parameter.

The additional information may be various combinations of the information described above. That is, the additional information may include at least one piece of information described above.

When an audio signal of a dependent channel corresponding to at least one audio signal of a BCG is present, the additional information generation unit 357 may generates dependent channel audio signal identification information indicating that the audio signal of the dependent channel is present.

The compression unit 370 may generate at least one substream by compressing at least one audio signal of at least one CG. Here, the compression may refer to compression based on various audio codecs. For example, the compression may include transformation and quantization processes.

The OBU packetization unit 390 may generate a bitstream including at least one substream of at least one CG and additional information. For example, the OBU packetization unit 390 may generate the bitstream of FIG. 2.

In order to generate the bitstream, the OBU packetization unit 390 may generate non-timed metadata including the codec information 220 and the static metadata 230. As illustrated in FIG. 2, the OBU packetization unit 390 may packetize the second OBU 212 and the codec information 220 and packetize the third OBU 213 and the static metadata 230.

Next, the OBU packetization unit 390 may generate timed metadata including the de-mixing information 240 and the CG information 250. As illustrated in FIG. 2, the OBU packetization unit 390 may packetize the fifth OBU 215 and the de-mixing information 240 and packetize the sixth OBU 216 and the CG information 250.

Next, the OBU packetization unit 390 may packetize the seventh OBU 217 and each of the at least one substream.

The operation in which the OBU packetization unit 390 generates the timed metadata and the operation in which the OBU packetization unit 390 packetizes the substream may be performed for each temporal unit (i.e., frame).

The OBU packetization unit 390 may generate a bitstream in the format in which the number of channels may be freely increased from the BCG.

That is, the audio signal of the BCG may be restored from the base channel audio stream, and the multi-channel audio signal having the channels, the number of which is increased from the BCG, may be restored from the base channel audio stream and the dependent channel audio stream.

On the other hand, the OBU packetization unit 390 may generate a file stream with a plurality of audio tracks. The OBU packetization unit 390 may generate an audio stream of a first audio track including at least one compressed audio signal of the BCG. The OBU packetization unit 390 may generate an audio stream of a second audio track including dependent channel audio signal identification information. At this time, the second audio track is an audio track after the first audio track and may be adjacent to each other.

When a dependent channel audio signal corresponding to at least one audio signal of the BCG is present, the OBU packetization unit 390 may generate the audio stream of the second audio track including at least one compressed audio signal of at least one DCG.

On the other hand, when a dependent channel audio signal corresponding to at least one audio signal of the BCG is not present, the OBU packetization unit 390 may generate the audio stream of the second audio track including the audio signal of the BCG next to the audio signal of the first audio track of the BCG.

FIG. 3C is a block diagram illustrating the configuration of the pre-processing unit according to an embodiment.

Referring to FIG. 3C, the pre-processing unit 350 may include a down-mix parameter generation unit 351, a down-mixing unit 353, and a CG generation unit 355. The down-mix parameter generation unit 351 may include an audio scene classification unit 352 and a height energy quantization unit 354.

The down-mix parameter generation unit 351 may generate down-mix parameters α, β, γ, δ, and w by using the original audio signal. Specifically, the audio scene classification unit 352 may generate the first to fourth down-mix parameters α, β, γ, and δ by using the original audio signal, and the height energy quantization unit 354 may generate the fifth down-mix parameter w by using the original audio signal. The first down-mix parameter α and the second down-mix parameter β may be parameters used to down-mix the number of surround channels from 7 channels to 5 channels. The third down-mix parameter γ may be a parameter used to down-mix the number of height channels from 4 channels to 2 channels. The fourth down-mix parameter δ may be a parameter used to down-mix the number of surround channels from 5 channels to 3 channels. The fifth down-mix parameter w may be a weight for mixing from the surround channel to the height channel.

The audio scene classification unit 352 may identify an audio scene type for the original audio signal and generate the first to fourth down-mix parameters α, β, γ, and δ, based on the identified audio scene type. For example, the audio scene classification unit 352 may generate the first to fourth down-mix parameters α, β, γ, and δ according to a down-mixing profile corresponding to the identified audio scene type. The first to fourth down-mix parameters α, β, γ, and δ corresponding to a specific audio scene type may be determined in advance. On the other hand, the audio scene type may be identified for each frame.

The audio scene classification unit 352 may downsample the original audio signal and identify the audio scene type, based on the downsampled original audio signal.

The audio scene classification unit 352 may obtain an audio signal of a center channel from the original audio signal. The audio scene classification unit 352 may identify a dialogue type from the obtained audio signal of the center channel. At this time, the audio scene classification unit 352 may identify the dialogue type by using a first neural network for identifying the dialogue type. Specifically, when a probability value of the dialogue type identified by using the first neural network is greater than a certain first probability value for a first dialogue type, the audio scene classification unit 352 may identify the first dialogue type as the dialogue type.

When the probability value of the dialogue type identified by using the first neural network is less than or equal to the certain first probability value for the first dialogue type, the audio scene classification unit 352 may identify a default dialogue type as the dialogue type.

The audio scene classification unit 352 may identify a sound effect type, based on a front channel audio signal and a side channel audio signal from the original audio signal.

The audio scene classification unit 352 may identify the sound effect type by using a second neural network for identifying the sound effect type. Specifically, when a probability value of the effect sound type identified by using the second neural network is greater than a certain second probability value for a first effect sound type, the audio scene classification unit 352 may identify the first effect sound type as the effect sound type.

When the probability value of the effect sound type identified by using the second neural network is less than or equal to the certain second probability value for the first effect sound type, the audio scene classification unit 352 may identify a default effect sound type as the effect sound type.

The audio scene classification unit 352 may identify an audio scene type, based on at least one of the identified dialogue type and the identified sound effect type. That is, the audio scene classification unit 352 may identify one audio scene type among a plurality of audio scene types.

The height energy quantization unit 354 may identify an energy value of the height channel of the original audio signal and an energy value of the surround channel of the original audio signal and may generate the fifth down-mix parameter w, based on the relative difference between the identified energy value of the height channel and the identified energy value of the surround channel. For example, the energy value of the surround channel may be a moving average value of a total power for the surround channel. Specifically, the energy value of the surround channel may be a root mean square energy (RMSE) value based on a long-term time window. For example, the energy value of the height channel may be a short time power value for the height channel. Specifically, the energy value of the height channel may be an RMSE value based on a short-term time window.

The height energy quantization unit 354 may identify an energy value of the height channel of the original audio signal and an energy value of the surround channel of the original audio signal and may identify a weight index offset wIdx_offset, based on the identified energy value of the height channel and the identified energy value of the surround channel.

When the energy value of the height channel is greater than a certain first value or a ratio between the energy value of the height channel and the energy value of the surround channel is greater than a certain second value, the height energy quantization unit 354 may identify the weight index offset wIdx_offset as a third value. For example, the third value may be −1.

When the energy value of the height channel is less than or equal to the certain first value or a ratio between the energy value of the height channel and the energy value of the surround channel is less than or equal to the certain second value, the height energy quantization unit 354 may identify the weight index offset wIdx_offset as a fourth value. For example, the fourth value may be 1.

On the other hand, the de-mixing information 240 may include the weight index offset wIdx_offset.

FIG. 3D illustrates a down-mix path based on a CL generation rule, according to an embodiment.

The down-mixing unit 353 may down-mix the original audio signal along a down-mix path determined in accordance with a CL generation rule by using the down-mix parameters α, β, γ, δ, and w.

The CL generation rule may be as follows.

When the number of surround channels of the first CL is Sᵢ, the number of subwoofer channels is Wᵢ, the number of height channels is Hᵢ, the number of surround channels of the second CL is Sᵢ₊₁, the number of subwoofer channels is Wᵢ₊₁, and the number of height channels is Hᵢ₊₁, Sᵢ may be less than or equal to Sin, Wᵢ may be less than or equal to Wᵢ₊₁, and Hᵢ may be less than or equal to Hᵢ₊₁. Here, a case where Sᵢ is equal to Sᵢ₊₁, Wᵢ is equal to Wᵢ₊₁, and Hᵢ is equal to Hᵢ₊₁ may be excluded.

That is, the number of surround channels of the second CL has to be greater than the number of surround channels of the first CL. Alternatively, the number of subwoofer channels of the second CL has to be greater than the number of subwoofer channels of the first CL. Alternatively, the number of height channels of the second CL has to be greater than the number of height channels of the first CL.

Additionally, the number of surround channels of the second CL has to be not less than the number of surround channels of the first CL. Similarly, the number of subwoofer channels of the second CL has to be not less than the number of subwoofer channels of the first CL. The number of height channels of the second CL has to be not less than the number of height channels of the first CL.

In addition, while the number of surround channels of the second CL is equal to the number of surround channels of the first CL, the number of subwoofer channels of the second CL may not be equal to the number of subwoofer channels of the first CL and the number of height channels of the second CL may not be equal to the number of height channels of the first CL. That is, all the channels of the second CL are not the same as all the channels of the first CL.

Referring to FIG. 3D, the down-mix path may be determined in accordance with the CL generation rule described above. That is, 7.1.4 channels may be down-mixed to 5.1.4 channels or 7.1.2 channels. 7.1.2 channels may be down-mixed to 5.1.2 channels or 7.1.0 channels. 7.1.0 channels may be down-mixed only to 5.1.0 channels. 5.1.4 channels may be down-mixed only to 5.1.2 channels. 5.1.2 channels may be down-mixed to 3.1.2 channels or 5.1.0 channels. 5.1.0 channels may be down-mixed only to 2.0.0 channels. 3.1.2 channels may be down-mixed only to 2.0.0 channels. 2.0.0 channels may be down-mixed only to 1.0.0 channels.

FIG. 3E illustrates a down-mix mechanism according to an embodiment.

As illustrated in FIG. 3E, the down-mixing unit 353 may individually down-mix the surround channel and the height channel of the original audio signal by using the down-mix parameters. At this time, the down-mixing unit 353 may perform down-mixing step by step from a starting channel to a target channel.

The surround channel S7 of the 7.x.x channel may be down-mixed to the surround channel S5 of the 5.x.x channel. At this time, the L7, C, and R7 channels of S7 may be down-mixed to be the same as the L5, C, and R5 channels of S5, respectively. The Lss7 and Lrs7 channels of S7 may be down-mixed to the Ls5 channel of S5 by using the first down-mix parameter α and the second down-mix parameter β. The Rss7 and Rrs7 channels of S7 may be down-mixed to the Rs5 channel of S5 by using the first down-mix parameter α and the second down-mix parameter β.

The surround channel S5 of the 5.x.x channel may be down-mixed to the surround channel S3 of the 3.x.x channel. At this time, the L5 and Ls5 channels of S5 may be down-mixed to the L3 channel of S3 by using the fourth down-mix parameter δ. The C channel of S5 may be down-mixed to be the same as the C channel of S3. At this time, the R5 and Rs5 channels of S5 may be down-mixed to the R3 channel of S3 by using the fourth down-mix parameter δ.

The surround channel S3 of the 3.x.x channel may be down-mixed to the 2.0.0 channel S2. At this time, the L3 and C channels of S3 may be down-mixed to the L2 channel of S2. The R3 and C channels of S3 may be down-mixed to the R2 channel of S2.

The 2.0.0 channel S2 may be down-mixed to the 1.0.0 channel S1. At this time, the L2 and R2 channels of S2 may be down-mixed to the mono channel of S1.

On the other hand, the height channel T4 of the 7.x.4 channel or the 5.x.4 channel may be down-mixed to the height channel T2 of the 7.x.2 channel or the 5.x.2 channel. At this time, the Ltf4 and Ltb4 channels of T4 may be down-mixed to the Ltf2 channel of T2 by using the third down-mix parameter γ. The Rtf4 and Rtb4 channels of T4 may be down-mixed to the Rtf2 channel of T2 by using the third down-mix parameter γ.

The height channel TF2 of the 3.x.2 channel may be generated by combining the surround channel and the height channel through the fifth down-mix parameter w and down-mixing the Ls5, Rs5, Ltf2, and Rtf2 channels.

For example, the down-mixing from the 7.1.4 channel to the 2.0.0 channel, the 3.1.2 channel, the 5.1.2 channel, and the 7.1.4 channel may be implemented by an operation using a down-mixing matrix as in Equation 1.

$$( \begin{matrix}L 2 \\ R 2 \\ C \\ Ltf 3 \\ Rtf 3 \\ LFE \\ L 5 \\ R 5 \\ Lss 7 \\ Rss 7 \\ Ltf \\ Rtf\end{matrix} ) = ( \begin{matrix}1 & {p}_{2} & 0 & δ * α & 0 & δ * β & 0 & 0 & 0 & 0 & 0 & 0 \\ 0 & {p}_{2} & 1 & 0 & δ * α & 0 & δ * β & 0 & 0 & 0 & 0 & 0 \\ 1 & 0 & 0 & 0 & 0 & 0 & 0 & 0 & 0 & 0 & 0 & 0 \\ 0 & 0 & 0 & w * δ * α & 0 & w * δ * β & 0 & 1 & 0 & γ & 0 & 0 \\ 0 & 0 & 0 & 0 & w * δ * α & 0 & w * δ * β & 0 & 1 & 0 & γ & 0 \\ 0 & 0 & 0 & 0 & 0 & 0 & 0 & 0 & 0 & 0 & 0 & 1 \\ 1 & 0 & 0 & 0 & 0 & 0 & 0 & 0 & 0 & 0 & 0 & 0 \\ 0 & 0 & 1 & 0 & 0 & 0 & 0 & 0 & 0 & 0 & 0 & 0 \\ 0 & 0 & 0 & 1 & 0 & 0 & 0 & 0 & 0 & 0 & 0 & 0 \\ 0 & 0 & 0 & 0 & 1 & 0 & 0 & 0 & 0 & 0 & 0 & 0 \\ 0 & 0 & 0 & 0 & 0 & 0 & 0 & 1 & 0 & 0 & 0 & 0 \\ 0 & 0 & 0 & 0 & 0 & 0 & 0 & 0 & 1 & 0 & 0 & 0\end{matrix} ) \times ( \begin{matrix}L \\ C \\ R \\ Lss \\ Rss \\ Lrs \\ Rrs \\ Ltf \\ Rtf \\ Ltb \\ Rtb \\ LFE\end{matrix} ) \qquad [ Equation 1 ]$$

Here, p2 may be 0.707 (i.e., −3 dB), and α, β, γ, δ, and w may be respectively the first to fifth down-mix parameters.

The CG generation unit 355 may generate at least one CG in accordance with the CG generation rule by using the down-mixed audio signals.

The CL generation rule may be as follows.

For a CL CLi (where i is an integer from 1 to n and CLi is Si·Wi·Hi), Si+Wi+Hi may be the number of channels for CG #i. The number of channels for CG #i may be greater than the number of channels for CG #i−1.

CG #i may include as many original channels (presentation channels) of CLi as possible. The original channels may follow the following priorities.

When Hᵢ₋₁ is 0, the high channel may have priority over other channels. The center channel and the LFE channel may have priority over other channels.

The height front channel may have priority over the side channel and the height back channel.

The side channel may have priority over the back channel. In addition, the left channel may have priority over the right channel.

For example, when n is 4, CL1 is 2.0.0 channel, CL2 is 3.1.2 channel, CL3 is 5.1.2 channel, and CL4 is 7.1.4 channel, CL1 may include L2 and R2 channels, CL2 may include C, Hfl3, Hfr3, and LFE channels, CL3 may include L5 and R5 channels, and CL4 may include Ls7, Rs7, Hfl, and Hfr channels.

FIG. 4A is a block diagram illustrating a configuration of a multi-channel audio decoding apparatus according to an embodiment.

The audio decoding apparatus 400 includes a memory 410 and a processor 430. The audio decoding apparatus 400 may be implemented as an apparatus capable of processing audio, such as a server, a TV, a camera, a mobile phone, a tablet PC, or a laptop.

Although the memory 410 and the processor 430 are illustrated separately in FIG. 4A, the memory 410 and the processor 430 may be implemented through a single hardware module (e.g., a chip).

The processor 430 may be implemented as a dedicated processor for neural network-based audio processing. Alternatively, the processor 430 may be implemented through a combination of software and a general-purpose processor, such as an AP, a CPU, or a GPU. The dedicated processor may include a memory for implementing an embodiment of the present disclosure, or may include a memory processing unit for using an external memory.

The processor 430 may include a plurality of processors. In this case, the processor 330 may be implemented through a combination of dedicated processors, or may be implemented through a combination of software and a plurality of general-purpose processors, such as AP, CPU, or GPU.

The memory 410 may store one or more instructions for audio processing. In an embodiment, the memory 410 may store a neural network. When the neural network is implemented in the form of a dedicated hardware chip for artificial intelligence or is implemented as part of an existing general-purpose processor (e.g., a CPU or an AP) or a dedicated graphics processor (e.g., a GPU), the neural network may not be stored in the memory 310. The neural network may be implemented by an external device (e.g., a server). In this case, the audio decoding apparatus 400 may request processing by the neural network from the external device and receive, from the external device, result information based on the neural network.

The processor 430 obtains consecutive decoded frames by sequentially processing consecutive frames according to instructions stored in the memory 410. The consecutive frames may refer to frames constituting audio.

The processor 430 may receive a bitstream as input, perform an audio processing operation, and output a multi-channel audio signal. At this time, the bitstream may be implemented in a scalable form so that the number of channels may be increased from the BCG. For example, the processor 430 may obtain a compressed audio signal of the BCG from the bitstream, and may restore an audio signal of the BCG (e.g., a stereo channel audio signal) by decompressing the compressed audio signal of the BCG. Additionally, the processor 430 may restore an audio signal of a DCG by decompressing a compressed audio signal of the DCG from the bitstream. The processor 430 may restore a multi-channel audio signal, based on the audio signal of the BCG and the audio signal of the DCG.

FIG. 4B is a block diagram illustrating a configuration of a multi-channel audio decoding apparatus according to an embodiment.

Referring to FIG. 4B, an audio decoding apparatus 400 may include an OBU parsing unit 450, a decompression unit 470, and a post-processing unit 490.

The audio decoding apparatus 400 may include the memory 410 and the processor 430 of FIG. 4A, and instructions for implementing respective components 450, 460, 470, and 480 of FIG. 4B may be stored in the memory 410. The processor 430 may execute the instructions stored in the memory 410.

The OBU parsing unit 450 may obtain at least one substream and additional information of at least one CG by parsing the bitstream.

In order to obtain the additional information, the OBU parsing unit 450 may obtain non-timed metadata including the codec information 220 and the static metadata 230. As illustrated in FIG. 2, the OBU parsing unit 450 may parse the second OBU 212 and the codec information 220 and parse the third OBU 213 and the static metadata 230.

Next, the OBU parsing unit 450 may obtain timed metadata including the de-mixing information 240 and the CG information 250. As illustrated in FIG. 2, the OBU parsing unit 450 may parse the fifth OBU 215 and the de-mixing information 240 and parse the sixth OBU 216 and the CG information 250.

Next, the OBU parsing unit 450 may parse the seventh OBU 217 and each of the at least one substream.

The operation in which the OBU parsing unit 450 obtains the timed metadata and the operation in which the OBU parsing unit 450 obtains the substream may be performed for each temporal unit (i.e., frame).

The decompression unit 470 may restore at least one audio signal of at least one CG by decompressing at least one substream.

The decompression unit 470 may restore the audio signal of the BCG by decompressing at least one compressed audio signal of the BCG.

The decompression unit 470 may restore at least one audio signal of at least one DCG by decompressing at least one compressed audio signal of at least one DCG.

At this time, the decompression unit 470 may include a first decompression unit, . . . , and an n^{th} decompression unit (not shown), which are separately provided for decoding the compressed audio signal of each CG (n CGs).

At this time, the first compression decompression unit, . . . , the n^{th} compression decompression unit (not shown) may operate in parallel with each other.

The post-processing unit 490 may restore at least one multi-channel audio signal by de-mixing at least one audio signal of at least one CG.

For example, the post-processing unit 490 may restore the audio signal of the 2.0.0 CL, the audio signal of the 3.1.2 CL, the audio signal of the 5.1.2 CL, and the audio signal of the 7.1.4 CL, based on the audio signals L2 and R2 of the first CG, the audio signals C, LFE, Hfl3, and Hfr3 of the second CG, the audio signals L5 and R5 of the third CG, and the audio signals Ls, Rs, Hfl, and Hfr of the fourth CG.

The post-processing unit 490 may generate an audio signal of an up-mix CG, based on the audio signal of the BCG and the audio signal of the DCG. At this time, the audio signal of the up-mix CG may be a multi-channel audio signal. At this time, a multi-channel audio signal may be additionally generated based on additional information (e.g., information about dynamic de-mixing weight parameters).

The post-processing unit 490 may generate an audio signal of an up-mix channel by de-mixing some of the audio signals of the BCG and the audio signals of the DCG. For example, the post-processing unit 490 may generate audio signals L3 and R3 of a de-mixed channel (or an up-mixed channel) by de-mixing the audio signals L and R of the BCG and some audio signals C of the DCG.

The post-processing unit 490 may generate audio signals of some channels among the multi-channel audio signals by bypassing the de-mixing operation for some of the audio signals of the DCG. For example, the post-processing unit 490 may generate audio signals of the C, LFE, Hfl3, and Hfr3 channels among the multi-channel audio signals by bypassing the de-mixing operation for audio signals of the C, LFE, Hfl3, and Hfr3 channels, which are some audio signals of the DCG.

Ultimately, the post-processing unit 490 may generate an audio signal of the up-mix CG, based on the audio signal of the up-mixed channel generated through de-mixing and the audio signal of the DCG for which the de-mixing operation is bypassed. For example, the post-processing unit 490 may generate audio signals of the L3, R3, C, LFE, Hfl3, and Hfr3 channels of the 3.1.2 channels, based on the audio signals of the L3 and R3 channels, which are the audio signals of the de-mixed channel, and the audio signals of the C, LFE, Hfl3, and Hfr3 channels, which are the audio signals of the DCG.

The post-processing unit 490 may individually de-mix the surround channel and the height channel by using de-mix parameters. The de-mix parameters may be configured to correspond to the down-mix parameters.

The 1.0.0 channel S1 may be de-mixed to the 2.0.0 channel S2.

The 2.0.0 channel S2 may be de-mixed to the surround channel S3 of the 3.x.x channel.

The surround channel S3 of the 3.x.x channel may be de-mixed to the surround channel S5 of the 5.x.x channel.

The surround channel S5 of the 5.x.x channel may be de-mixed to the surround channel S7 of the 7.x.x channel.

The height channel TF2 of the 3.x.2 channel may be de-mixed to the height channel T2 of the 7.x.2 channel or the 5.x.2 channel.

The height channel T2 of the 7.x.2 channel or the 5.x.2 channel may be de-mixed to the height channel T4 of the 7.x.4 channel or the 5.x.4 channel.

The surround channel de-mixing and height channel de-mixing described above may be implemented by operations as in Equation 2.

$$R 2 = 2 \times Mono - L 2 \qquad [ Equation 2 ]$$

$$L 3 = L 2 - 0.707 \times C$$

$$R 3 = R 2 - 0.707 \times C$$

$$Ls = 1 / δ \times ( L 3 - L 5 )$$

$$Rs = 1 / δ \times ( R 3 + R 5 )$$

$$Lrs = 1 / β \times ( Ls - α Lss )$$

$$Rrs = 1 / β \times ( Rs - α Rss )$$

$$Ltf 2 = Ltf 3 - w \times ( L 3 - L 5 )$$

$$Rtf 2 = Rtf 3 - w \times ( R 3 - R 5 )$$

$$Ltb = 1 / γ \times ( Ltf 2 - Ltf 4 )$$

$$Rtb = 1 / γ \times ( Rtf 2 - Rtf 4 )$$

Here, α, β, γ, δ, and w are respectively the first to fifth down-mix parameters.

The post-processing unit 490 may restore at least one multi-channel audio signal by de-mixing at least one audio signal of at least one CG by using the de-mix parameters corresponding to the down-mix parameters.

The post-processing unit 490 may dynamically determine the fifth down-mix parameter by using the weight index offset wIdx_offset. The post-processing unit 490 may perform height channel de-mixing, based on the dynamically determined fifth down-mix parameter. The de-mixing from the TF channel to the T2 channel or the down-mixing from the T2 channel to the TF channel is performed by using the audio signal of the surround channel as well as the audio signal of the height channel. At this time, when the audio signal of the surround channel is suddenly added or removed at an excessively large rate, a user feels a sense of sound heterogeneity. To allow users to experience natural sounds, the post-processing unit 490 may dynamically determine the fifth down-mix parameter w, based on the weight index offset wIdx_offset.

FIG. 4C is an example of a relationship between the weight index wIdx and the fifth down-mix parameter w, according to an embodiment.

Referring to FIG. 4C, for example, the weight index wIdx may be an integer from 0 to 10, and the fifth down-mix parameter w may have a value from 0 to 0.5 according to the value of the weight index wIdx. The weight index wIdx may be reset to 0 in advance before encoding the audio signal. The weight index wIdx is a value obtained by cumulatively adding the weight index offset wIdx_offset for every frame (temporal unit). For example, when the weight index offset wIdx_offset is 1 for each frame, the weight index wIdx increases by 1, and when the weight index offset wIdx_offset is −1 for each frame, the weight index wIdx decreases by 1. When the weight index wIdx is out of the range of 0 to 10, the weight index wIdx may be maintained at 0 or 10. The weight index wIdx may be implemented as in Equation 3.

$$wIdx = clip 3 ( 0 , 10 , wIdx\_p + wIdx\_offset ) where \qquad [ Equation 3 ]$$

$$clip 3 ( min , max , x ) = \{ \begin{matrix}max ; x > max \\ min ; x < min \\ x ; otherwise\end{matrix}$$

Here, wIdx_p is a previous wIdx value.

According to an embodiment, the audio decoding apparatus 400 may provide sound without a sense of heterogeneity to users by gradually adding or removing the audio signal of the surround channel when de-mixing from the HF2 channel to the H2 channel.

The post-processing unit 490 may restore a multi-channel audio signal, based on additional information as well as the audio signal of the BCG and the audio signal of the DCG. At this time, the additional information may be additional information for restoration of the multi-channel audio signal. The multi-channel post-processing unit 490 may output at least one restored multi-channel audio signal.

The post-processing unit 490 according to an embodiment may generate a first audio signal of a listener front three-dimensional audio channel from at least one audio signal of the BCG and at least one audio signal of the at least one DCG. The post-processing unit 490 may restore a multi-channel audio signal including a second audio signal of the listener front three-dimensional audio channel, based on the first audio signal and an audio object signal of the listener front audio channel. At this time, the audio object signal may indicate at least one of an audio signal, a shape, an area, a location, and a direction of the audio object (sound source) and may be obtained from the OBU parsing unit 450.

In addition, the post-processing unit 490 may control the loudness of the audio signal of each channel to a target loudness (e.g., −24 LKFS), based on loudness information signaled through the bitstream and output the target loudness. The loudness of the audio signal of each channel may be measured based on ITU-R BS.1770, and may be signaled through additional information of the bitstream.

On the other hand, the level of the audio signal generated by mixing signals of a plurality of channels in the audio encoding apparatus 300 is lowered by using the down-mix gain so as to prevent clipping. The post-processing unit 490 may adjust the level of the audio signal to the level of the original audio signal, based on the corresponding down-mix gain for the mixed signal.

On the other hand, the above-described operation based on the down-mix gain may be performed for each channel or CG. At this time, the audio encoding apparatus 300 may signal information about the down-mix gain for each channel or CG through the additional information of the bitstream. Accordingly, the audio decoding apparatus 400 may obtain the information about the down-mix gain for each channel or CG from the additional information of the bitstream and perform the above-described operation, based on the down-mix gain.

On the other hand, the post-processing unit 490 may perform the de-mixing operation, based on the dynamic de-mix parameters of the de-mixing matrix (corresponding to the down-mix parameters of the down-mixing matrix). At this time, the audio encoding apparatus 300 may signal the dynamic de-mix parameters or the dynamic down-mix parameters corresponding thereto through the additional information of the bitstream. Some de-mix parameters may not be signaled and may have fixed values.

Therefore, the audio decoding apparatus 400 may obtain information about the dynamic de-mix parameters (or information about the dynamic down-mix parameters) from the additional information of the bitstream, and may perform the de-mixing operation, based on the obtained information about the dynamic de-mix parameters (or the information about the dynamic down-mix parameters).

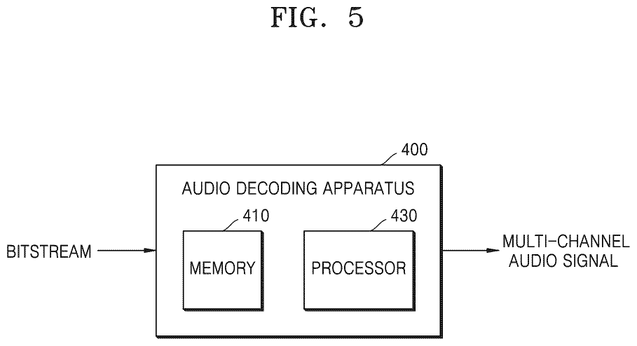

FIG. 5 is a flowchart of an audio processing method according to an embodiment.

In operation 510, the audio processing method may generate down-mix parameters by using an audio signal.

In operation 530, the audio processing method may down-mix the audio signal along a down-mix path determined in accordance with a CL generation rule, by using the down-mix parameters.

In operation 550, the audio processing method may generate at least one CG in accordance with a CG generation rule by using the down-mixed audio signal.

In operation 570, at least one substream 260 may be generated by compressing the at least one audio signal of the at least one CG.

In operation 590, the bitstream 200 may be generated by packetizing the at least one substream 260 and additional information.

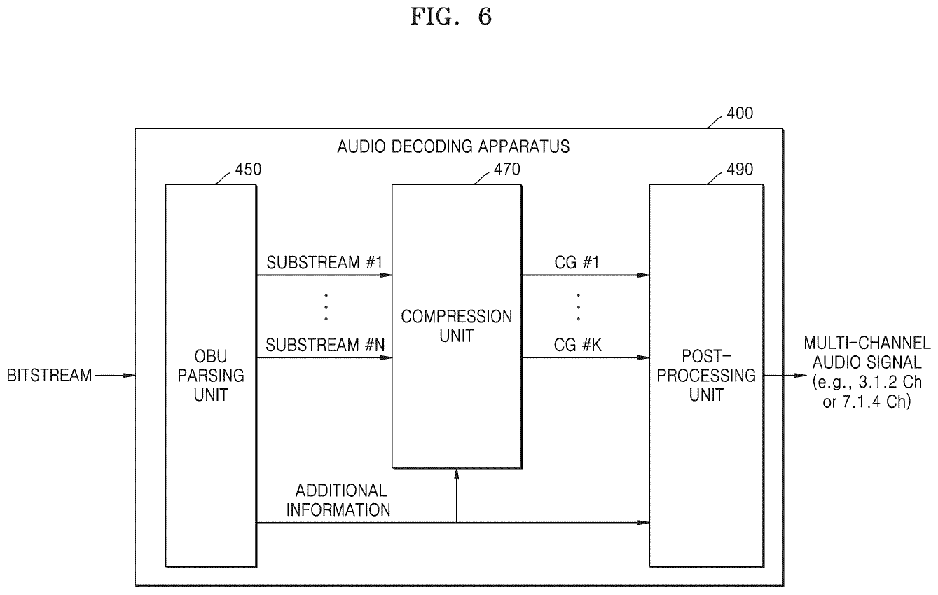

FIG. 6 is a flowchart of an audio processing method according to an embodiment.

In operation 610, at least one substream 260 and additional information may be obtained by parsing a bitstream 200.

In operation 630, at least one audio signal of at least one CG may be obtained by decompressing the at least one substream 260.

In operation 650, a multi-channel audio signal may be obtained by de-mixing the at least one audio signal of the at least one CG, based on the additional information.

A machine-readable storage medium may be provided in the form of a non-transitory storage medium. The non-transitory storage medium is a tangible device and only means not including a signal (e.g., electromagnetic wave). This term does not distinguish between a case where data is semi-permanently stored in a storage medium and a case where data is temporarily stored in a storage medium. For example, the non-transitory storage medium may include a buffer in which data is temporarily stored.

According to an embodiment, the methods according to various embodiments disclosed herein may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or a memory of a relay server, or may be temporarily generated.

In an embodiment, an audio processing method may include obtaining at least one substream and additional information by parsing a bitstream.

In an embodiment, the audio processing method may include obtaining at least one audio signal of at least one CG by decompressing the at least one substream.

In an embodiment, the audio processing method may include obtaining a multi-channel audio signal by de-mixing the at least one audio signal of the at least one CG, based on the additional information.

In an embodiment, the additional information may include a weight index offset (wIdx_offset) identified based on an energy value of a height channel of the multi-channel audio signal and an energy value of a surround channel of the multi-channel audio signal.

In an embodiment, the additional information may further include first to fifth down-mix parameters (α, β, γ, δ, and w).

In an embodiment, the obtaining of the multi-channel audio signal may include de-mixing the surround channel of the at least one audio signal, based on the first to fourth down-mix parameters (α, β, γ, and δ).

In an embodiment, the obtaining of the multi-channel audio signal may include dynamically determining the fifth down-mix parameter (w) by using the weight index offset (wIdx_offset).

In an embodiment, the obtaining of the multi-channel audio signal may include de-mixing a height channel of the at least one audio signal, based on the fifth down-mix parameter (w).

In an embodiment, the dynamic determining of the fifth down-mix parameter (w) by using the weight index offset (wIdx_offset) may include determining a weight index (wIdx) by cumulatively adding the weight index offset (wIdx_offset) for each frame.

In an embodiment, the dynamic determining of the fifth down-mix parameter (w) by using the weight index offset (wIdx_offset) may include determining the fifth down-mix parameter (w) as a predetermined value corresponding to the weight index (wIdx).

In an embodiment, the determining of the weight index (wIdx) may include, when a result of cumulatively adding the weight index offset (wIdx_offset) for each frame is less than or equal to a first value, determining the weight index (wIdx) to be the first value, when the result of cumulatively adding the weight index offset (wIdx_offset) for each frame is greater than a second value, determining the weight index (wIdx) to be the second value, and when the result of cumulatively adding the weight index offset (wIdx_offset) for each frame is a third value greater than the first value and less than the second value, determining the weight index (wIdx) to be the third value.

In an embodiment, the bitstream may be configured in a form of an open bitstream unit (OBU) packet.

In an embodiment, the bitstream may include non-timed metadata including at least one of codec information and static metadata, and at least one temporal unit including de-mixing information and the at least one substream.

In an embodiment, an audio processing apparatus may include a memory storing one or more instructions for audio processing, and at least one processor configured to execute the one or more instructions.

In an embodiment, the at least one processor may obtain at least one substream and additional information by parsing a bitstream.

In an embodiment, the at least one processor may obtain at least one audio signal of at least one CG by decompressing the at least one substream.

In an embodiment, the at least one processor may obtain a multi-channel audio signal by de-mixing the at least one audio signal of the at least one CG, based on the additional information.

In an embodiment, the additional information may include a weight index offset (wIdx_offset) identified based on an energy value of a height channel of the multi-channel audio signal and an energy value of a surround channel of the multi-channel audio signal.

In an embodiment, the additional information may further include first to fifth down-mix parameters (α, β, γ, δ, and w).

In an embodiment, the at least one processor may de-mix the surround channel of the at least one audio signal, based on the first to fourth down-mix parameters (α, β, γ, and δ).

In an embodiment, the at least one processor may dynamically determine the fifth down-mix parameter (w) by using the weight index offset (wIdx_offset).

In an embodiment, the at least one processor may de-mix the height channel of the at least one audio signal, based on the fifth down-mix parameter (w).

In an embodiment, the at least one processor may determine a weight index (wIdx) by cumulatively adding the weight index offset (wIdx_offset) for each frame.

In an embodiment, the at least one processor may determine the fifth down-mix parameter (w) as a predetermined value corresponding to the weight index (wIdx).

In an embodiment, the at least one processor may, when a result of cumulatively adding the weight index offset (wIdx_offset) for each frame is less than or equal to a first value, determine the weight index (wIdx) to be the first value, when the result of cumulatively adding the weight index offset (wIdx_offset) for each frame is greater than a second value, determine the weight index (wIdx) to be the second value, and when the result of cumulatively adding the weight index offset (wIdx_offset) for each frame is a third value greater than the first value and less than the second value, determine the weight index (wIdx) to be the third value.

In an embodiment, the bitstream may be configured in the form of an open bitstream unit (OBU) packet.

In an embodiment, the bitstream may include non-timed metadata including at least one of codec information and static metadata, and at least one temporal unit including de-mixing information and the at least one substream.

In an embodiment, the audio processing method may include generating a down-mix parameter by using an audio signal.

In an embodiment, the audio processing method may include down-mixing the audio signal along a down-mix path determined in accordance with a CL generation rule, by using the down-mix parameter.

In an embodiment, the audio processing method may include generating at least one CG in accordance with a CG generation rule by using the down-mixed audio signal.

In an embodiment, the audio processing method may include generating at least one substream by compressing the at least one audio signal of the at least one CG.

In an embodiment, the audio processing method may include generating a bitstream by packetizing the at least one substream and additional information.

In an embodiment, the additional information may include a weight index offset (wIdx_offset) identified based on an energy value of a height channel of the audio signal and an energy value of a surround channel of the audio signal.

In an embodiment, the down-mix parameter may include first to fifth down-mix parameters (α, β, γ, δ, and w).

In an embodiment, the generating of the down-mix parameter may include identifying an audio scene type for the audio signal.

In an embodiment, the generating of the down-mix parameter may include generating the first to fourth down-mix parameters (α, β, γ, and δ), based on the identified audio scene type.

In an embodiment, the generating of the down-mix parameter may include identifying the energy value of the height channel of the audio signal and the energy value of the surround channel of the audio signal.

In an embodiment, the generating of the down-mix parameter may include generating the fifth down-mix parameter (w), based on a relative difference between the identified energy value of the height channel and the identified energy value of the surround channel.

In an embodiment, the generating of the down-mix parameter may include identifying the weight index offset (wIdx_offset), based on the identified energy value of the height channel and the identified energy value of the surround channel.

In an embodiment, the down-mixing of the audio signal may include down-mixing the surround channel of the audio signal by using the first to fourth down-mix parameters (α, β, γ, and δ).

In an embodiment, the down-mixing of the audio signal may include down-mixing the height channel of the audio signal by using the fifth down-mix parameter (w).

In an embodiment, the down-mixing of the height channel may further include down-mixing the height channel by combining, through the fifth down-mix parameter (w), at least one audio signal included in the surround channel and at least one audio signal included in the height channel.

In an embodiment, the bitstream may be configured in a form of an open bitstream unit (OBU) packet.

In an embodiment, the bitstream may include non-timed metadata including at least one of codec information and static metadata, and at least one temporal unit including de-mixing information and the at least one substream.

In an embodiment, an audio processing apparatus may include a memory storing one or more instructions for audio processing, and at least one processor configured to execute the one or more instructions.

In an embodiment, the at least one processor may generate a down-mix parameter by using an audio signal.

In an embodiment, the at least one processor may down-mix the audio signal along a down-mix path determined in accordance with a CL generation rule, by using the down-mix parameter.

In an embodiment, the at least one processor may generate at least one CG in accordance with a CG generation rule by using the down-mixed audio signal.

In an embodiment, the at least one processor may generate at least one substream by compressing the at least one audio signal of the at least one CG.

In an embodiment, the at least one processor may generate a bitstream by packetizing the at least one substream (260) and additional information.

In an embodiment, the additional information may include a weight index offset (wIdx_offset) identified based on an energy value of a height channel of the audio signal and an energy value of a surround channel of the audio signal.

In an embodiment, the down-mix parameter may include first to fifth down-mix parameters (α, β, γ, δ, and w).

In an embodiment, the at least one processor may identify an audio scene type for the audio signal.

In an embodiment, the at least one processor may generate the first to fourth down-mix parameters (α, β, γ, and δ), based on the identified audio scene type.

In an embodiment, the at least one processor may identify the energy value of the height channel of the audio signal and the energy value of the surround channel of the audio signal.

In an embodiment, the at least one processor may generate the fifth down-mix parameter (w), based on a relative difference between the identified energy value of the height channel and the identified energy value of the surround channel.

In an embodiment, the at least one processor may identify the weight index offset (wIdx_offset), based on the identified energy value of the height channel and the identified energy value of the surround channel.

In an embodiment, the at least one processor may down-mix the surround channel of the audio signal by using the first to fourth down-mix parameters (α, β, γ, and δ).

In an embodiment, the at least one processor may down-mix the height channel of the audio signal by using the fifth down-mix parameter (w).

In an embodiment, the at least one processor may down-mix the height channel by combining, through the fifth down-mix parameter (w), at least one audio signal included in the surround channel and at least one audio signal included in the height channel.

In an embodiment, the bitstream may be configured in a form of an open bitstream unit (OBU) packet.

In an embodiment, the bitstream may include non-timed metadata including at least one of codec information and static metadata, and at least one temporal unit including de-mixing information and the at least one substream.

What is claimed is:

1. An audio processing method comprising:
obtaining at least one substream and additional information by parsing a bitstream;
obtaining at least one audio signal of at least one channel group (CG) by decompressing the at least one substream; and
obtaining a multi-channel audio signal by de-mixing the at least one audio signal of the at least one CG, based on the additional information,
wherein the additional information comprises a weight index offset identified based on an energy value of a height channel of the multi-channel audio signal and an energy value of a surround channel of the multi-channel audio signal.

2. The audio processing method of claim 1, wherein the additional information further comprises a first down-mix parameter, a second down-mix parameter, a third down-mix parameter, a fourth down-mix parameter, and a fifth down-mix parameter, and
wherein the obtaining of the multi-channel audio signal comprises:
de-mixing the surround channel of the at least one audio signal, based on the first down-mix parameter, the second down-mix parameter, the third down-mix parameter, and the fourth down-mix parameter;
dynamically determining the fifth down-mix parameter by using the weight index offset; and
de-mixing a height channel of the at least one audio signal, based on the fifth down-mix parameter.

3. The audio processing method of claim 2, wherein the dynamically determining of the fifth down-mix parameter by using the weight index offset comprises:
determining a weight index by cumulatively adding the weight index offset for each frame; and
determining the fifth down-mix parameter as a predetermined value corresponding to the weight index.

4. The audio processing method of claim 3, wherein the determining of the weight index comprises:
based on a result of cumulatively adding the weight index offset for each frame being less than or equal to a first value, determining the weight index to be the first value;
based on the result of cumulatively adding the weight index offset for each frame being greater than a second value, determining the weight index to be the second value; and
based on the result of cumulatively adding the weight index offset for each frame being a third value greater than the first value and less than the second value, determining the weight index to be the third value.

5. The audio processing method of claim 1, wherein the bitstream is configured in a form of an open bitstream unit packet, and
wherein the bitstream comprises:
non-timed metadata including at least one of codec information or static metadata; and
at least one temporal unit including de-mixing information and the at least one substream.

6. An audio processing method comprising:
generating a down-mix parameter by using an audio signal;
down-mixing the audio signal along a down-mix path determined in accordance with a channel layout generation rule, by using the down-mix parameter;
generating at least one channel group in accordance with a channel group (CG) generation rule by using the down-mixed audio signal;
generating at least one substream by compressing the at least one audio signal of the at least one CG; and
generating a bitstream by packetizing the at least one substream and additional information,
wherein the additional information comprises a weight index offset identified based on an energy value of a height channel of the audio signal and an energy value of a surround channel of the audio signal.

7. The audio processing method of claim 6, wherein the down-mix parameter comprises a first down-mix parameter, a second down-mix parameter, a third down-mix parameter, a fourth down-mix parameter, and a fifth down-mix parameter, and
wherein the generating of the down-mix parameter comprises:
identifying an audio scene type for the audio signal;
generating the first down-mix parameter, the second down-mix parameter, the third down-mix parameter, and the fourth down-mix parameter, based on the identified audio scene type;
identifying the energy value of the height channel of the audio signal and the energy value of the surround channel of the audio signal; and
generating the fifth down-mix parameter, based on a relative difference between the identified energy value of the height channel and the identified energy value of the surround channel.

8. The audio processing method of claim 6, wherein the generating of the down-mix parameter further comprises identifying the weight index offset, based on the identified energy value of the height channel and the identified energy value of the surround channel.

9. The audio processing method of claim 7, wherein the down-mixing of the audio signal comprises:
down-mixing the surround channel of the audio signal by using the first down-mix parameter, the second down-mix parameter, the third down-mix parameter, and the fourth down-mix parameter; and
down-mixing the height channel of the audio signal by using the fifth down-mix parameter.

10. The audio processing method of claim 7, wherein the down-mixing of the height channel further comprises down-mixing the height channel by combining, through the fifth down-mix parameter, at least one audio signal included in the surround channel and at least one audio signal included in the height channel.

11. The audio processing method of claim 6, wherein the bitstream is configured in a form of an open bitstream unit packet, and
wherein the bitstream comprises:
non-timed metadata including at least one of codec information or static metadata; and
at least one temporal unit including de-mixing information and the at least one substream.

12. A computer-readable recording medium having stored thereon a computer program that, when executed by a processor, causes the processor to perform the method of claim 6.

13. An audio processing apparatus comprising:
a memory storing one or more instructions for audio processing; and
at least one processor,
wherein the one or more instructions, when executed by the at least one processor, cause the audio processing apparatus to:
obtain at least one substream and additional information by parsing a bitstream;
obtain at least one audio signal of at least one channel group (CG) by decompressing the at least one substream; and
obtain a multi-channel audio signal by de-mixing the at least one audio signal of the at least one CG, based on the additional information,
wherein the additional information comprises a weight index offset identified based on an energy value of a height channel of the multi-channel audio signal and an energy value of a surround channel of the multi-channel audio signal.

14. An audio processing apparatus comprising:
a memory storing one or more instructions for audio processing; and
at least one processor,
wherein the one or more instructions, when executed by the at least one processor, cause the audio processing apparatus to:
generate a down-mix parameter by using an audio signal;
down-mix the audio signal along a down-mix path determined in accordance with a channel layout generation rule, by using the down-mix parameter;
generate at least one channel group in accordance with a channel group (CG) generation rule by using the down-mixed audio signal;
generate at least one substream by compressing the at least one audio signal of the at least one CG; and
generate a bitstream by packetizing the at least one substream and additional information,
wherein the additional information comprises a weight index offset identified based on an energy value of a height channel of the audio signal and an energy value of a surround channel of the audio signal.
